(19) United States
(12) Patent Application Publication
(10) Pub. No.: US 2009/0168188 A1
(43) Pub. Date: Jul. 2, 2009

(54) IMAGE FORMING APPARATUS, OPTICAL SCANNING DEVICE, AND PLASTIC LENS

(76) Inventors: Go TAKAHASHI, Ebina-shi (JP); Eiichi HAYASHI, Atsugi-shi (JP); Kan AOKI, Yamato-shi (JP); Akihiro IWAMATSU, Ebina-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/339,604

(22) Filed: Dec. 19, 2008

(30) Foreign Application Priority Data
Dec. 28, 2007 (JP) 2007-339700

(51) Int. Cl. G02B 3/00; B28B 1/00

(52) U.S. Cl. 359/642; 425/425

(57) ABSTRACT

A plastic lens molded in a mold having two first molding blocks and two second molding blocks. The first molding blocks transfer light incidence and emission surfaces. The second molding blocks are provided to both ends of the first molding blocks, disposed parallel to an optical axis and facing each other, and transfer non-light-passing surfaces. At least one of the second molding blocks includes an elongated slit-like ventilation hole having a length of a light effective range or longer and extending in a main scanning direction of the light incidence and emission surfaces along positions equidistant from the light incidence and emission surfaces. Through the ventilation hole, air is sprayed onto molten resin in a process of resin cooling and solidification to facilitate cooling of the resin.

### CROSS-REFERENCE TO RELATED APPLICATION

This application claims priority to Japanese Patent Application No. 2007-339700, filed on Dec. 28, 2007, the entire contents of which are hereby incorporated by reference herein.

### BACKGROUND OF THE INVENTION

1. Field of the Invention

The present invention relates to an image forming apparatus, such as a color digital copier, a multifunction printer (MFP), a laser printer, a facsimile machine, a plotter, and a multifunctional machine combining the functions of these apparatuses, an optical scanning device, and a plastic lens incorporated in the image forming apparatus and the optical scanning device.

2. Discussion of the Background Art

An existing optical writing unit installed in a laser-type digital copier, printer, facsimile machine, or the like includes, as a main component thereof, a rectangular optical device (e.g., a lens and a mirror) having a function of forming an image from laser light and correcting the formed image.

To reduce the cost, a plastic material has been increasingly used to form the optical device installed in the optical writing unit. Further, an optical device has been known which has a mirror surface formed into a complicated aspheric shape to realize a plurality of functions of the optical writing unit with a minimum number of components. Further, another optical device has been known which is a lens designed to have an uneven thickness in a longitudinal direction. The optical devices as described above can be mass-produced at relatively low cost with the use of a mold having a cavity of a special shape according to a desired function of the optical devices.

Resin molding of the optical device involves a process of cooling and solidifying a molten resin within the cavity. In the process, it is necessary to reduce internal strain on the resin. Therefore, an operation of reducing the resin pressure in the cavity is performed. Further, to improve shape accuracy, it is desirable to homogenize the temperature distribution of the molten resin.

If the pressure of the molten resin in the cavity is reduced, however, the resin contracts in the subsequent cooling and solidification process. As a result, the resin separates from a surface of the mold, and a depression is formed in an optical functional surface of the optical device. Further, in the molding of a thick optical device which is uneven in thickness, the cooling speed of the resin is naturally different from site to site. The difference results in a difference in the contraction amount of the resin. As a result, such phenomena as deterioration of the shape accuracy and internal strain occur.

To prevent the deterioration of optical performance caused by such phenomena as the depression of the resin, the deterioration of the shape accuracy, and the occurrence of the internal strain as described above, one background technique has been proposed that provides a ventilation hole to a molding block of a mold, which forms, or transfers, a non-light-passing surface of a lens. According to this method, air is sprayed against the non-light-passing surface through the ventilation hole to pneumatically press the resin and increase the cooling temperature of a central portion of the resin.

In such background technique, however, the ventilation hole used to spray air is not formed into a shape corresponding to the individual shape of an intended plastic lens, but is formed into a uniform shape. Therefore, if the intended optical device is of a shape having an uneven thickness or a shape substantially curved in a longitudinal direction, air may be sprayed against a region near a light incidence or emission surface, or a depression may be formed in the light incidence or emission surface.

Further, if the ventilation hole has a uniform shape, the degree of operational freedom is inevitably reduced. As a result, it is difficult to perform an operation of guiding the depression to a surface other than the light incidence or emission surface.

Further, it is difficult to preferentially cool a central portion of the plastic lens, i.e., a portion in which the cooling speed of the resin is slowest, and consequently the resin temperature distribution may become inhomogeneous.

### SUMMARY OF THE INVENTION

This patent specification describes a plastic lens. In one example, a plastic lens is molded in a mold for molding a plastic lens. The mold for molding a plastic lens includes a pair of first molding blocks and a pair of second molding blocks. The first molding blocks transfer light incidence and emission surfaces. The second molding blocks are provided to both ends of the first molding blocks, disposed parallel to an optical axis and facing each other, and transfer non-light-passing surfaces. At least one of the second molding blocks includes an elongated slit-like ventilation hole having a length of a light effective range or longer and extending in a main scanning direction of the light incidence and emission surfaces along positions equidistant from the light incidence and emission surfaces. Through the ventilation hole, air is sprayed onto molten resin in a process of resin cooling and solidification to facilitate cooling of the resin.

This patent specification further describes an optical scanning device. In one example, an optical scanning device includes a plastic lens molded in a mold for molding a plastic lens. The mold for molding a plastic lens includes a pair of first molding blocks and a pair of second molding blocks. The first molding blocks transfer light incidence and emission surfaces. The second molding blocks are provided to both ends of the first molding blocks, disposed parallel to an optical axis and facing each other, and transfer non-light-passing surfaces. At least one of the second molding blocks includes an elongated slit-like ventilation hole having a length of a light effective range or longer and extending in a main scanning direction of the light incidence and emission surfaces along positions equidistant from the light incidence and emission surfaces. Through the ventilation hole, air is sprayed onto molten resin in a process of resin cooling and solidification to facilitate cooling of the resin.

This patent specification further describes an image forming apparatus. In one example, an image forming apparatus includes an optical scanning device including a plastic lens molded in a mold for molding a plastic lens. The first molding blocks transfer light incidence and emission surfaces. The second molding blocks are provided to both ends of the first molding blocks, disposed parallel to an optical axis and facing each other, and transfer non-light-passing surfaces. At least one of the second molding blocks includes an elongated slit-like ventilation hole having a length of a light effective range or longer and extending in a main scanning direction of the light incidence and emission surfaces along positions equidistant from the light incidence and emission surfaces. Through the ventilation hole, air is sprayed onto molten resin in a process of resin cooling and solidification to facilitate cooling of the resin.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a schematic cross-sectional view of a cavity of a mold for molding a plastic lens;

FIG. 2 is a schematic plan view of the cavity, as viewed in the direction indicated by arrow A in FIG. 1;

FIG. 3 is a schematic plan view of another example of the cavity, as viewed in the direction indicated by the arrow A in FIG. 1;

FIG. 4 is a schematic plan view of another example of the cavity, as viewed in the direction indicated by the arrow A in FIG. 1;

FIG. 5 is a schematic plan view of another example of the cavity, as viewed in the direction indicated by the arrow A in FIG. 1;

FIG. 6 is a schematic plan view of another example of the cavity, as viewed in the direction indicated by the arrow A in FIG. 1;

FIG. 7 is a schematic plan view of another example of the cavity, as viewed in the direction indicated by the arrow A in FIG. 1;

FIG. 8 is a schematic plan view of another example of the cavity, as viewed in the direction indicated by the arrow A in FIG. 1;

FIG. 9 is a schematic plan view of another example of the cavity, as viewed in the direction indicated by the arrow A in FIG. 1;

FIG. 10 is a schematic cross-sectional view of a cavity of a mold for molding a plastic lens;

FIG. 11 is a schematic plan view of the cavity, as viewed in the direction indicated by arrow B in FIG. 10;

FIG. 12 is a schematic plan view of another example of the cavity, as viewed in the direction indicated by the arrow B in FIG. 10;

FIG. 13 is a schematic cross-sectional view of a cavity of a mold for molding a plastic lens;

FIG. 14 is a schematic cross-sectional view of a cavity of a mold for molding a plastic lens;

FIG. 15 is a schematic cross-sectional view of a cavity of a mold for molding a plastic lens;

FIG. 16 is a schematic perspective view of a plastic lens;

FIG. 17 is a schematic perspective view of a plastic lens;

FIG. 18 is a schematic configuration view of essential parts of an example of an optical scanning device;

FIG. 19 is a schematic configuration view of essential parts of another example of the optical scanning device; and

FIG. 20 is a schematic side view of the essential parts of the example of the optical scanning device illustrated in FIG. 18.

### DETAILED DESCRIPTION OF THE INVENTION

In describing the embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner.

Referring now to the drawings, wherein like reference numerals designate identical or corresponding parts throughout the several views, a mold for molding a plastic lens according to an embodiment of the present invention will be described.

The mold for molding a plastic lens includes a pair of first molding blocks and a pair of second molding blocks. The first molding blocks are configured to transfer a light incidence surface and a light emission surface, respectively. The second molding blocks are provided to both end portions of the first molding blocks to be parallel to a light beam direction and to face each other, and each of the second molding blocks is configured to transfer a non-light-passing surface. At least one of the second molding blocks includes a ventilation hole formed into an elongated slit extending in a main scanning direction of the light incidence surface and the light emission surface. The ventilation hole has a length equal to or longer than a light effective range, and extends along a line defined by positions each apart from the light incidence surface and the light emission surface by a substantially equal distance. The mold for molding a plastic lens is employed in a molding step of a cooling and solidification process of a molten resin to spray air onto the resin through the ventilation hole to facilitate cooling of the resin.

An embodiment of the present invention will be described. With reference to the drawings, a mold according to the embodiment of the present invention will be described.

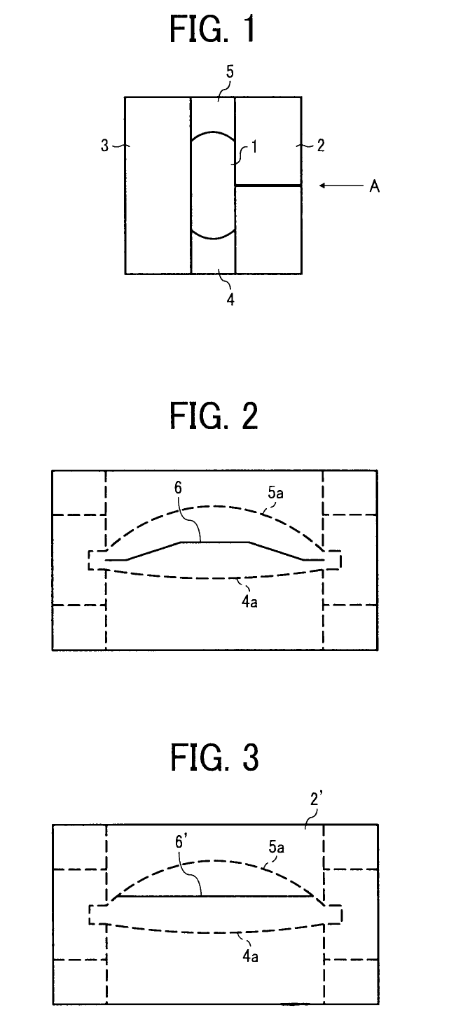

FIG. 1 is a schematic view of a cavity of a mold for molding a plastic lens, as viewed in a longitudinal direction of the intended plastic lens. In FIG. 1, the reference numeral 1 denotes the cavity to be filled with a resin, and the reference numerals 2 to 5 denote molding blocks, which are components forming the cavity. Specifically, the reference numerals 2 and 3 denote molding blocks which transfer non-light-passing surfaces of an intended optical device, i.e., the plastic lens. The reference numerals 4 and 5 denote molding blocks which transfer a light incidence surface 4a and a light emission surface 5a, respectively, which are illustrated in FIG. 2.

FIG. 2 is a schematic view of the cavity of FIG. 1, as viewed in the direction indicated by arrow A. FIG. 2 illustrates the positional correspondence relationship between the ultimately intended plastic lens indicated by a broken line in the drawing and a ventilation hole 6 provided in the molding block 2 forming the cavity. In the present example, the ventilation hole 6 extends along a line defined by positions each apart from the light incidence surface 4a and the light emission surface 5a by a substantially equal distance.

FIG. 3 is a schematic plan view of another example of the cavity of FIG. 1, as viewed in the direction indicated by the arrow A. In the present example, a molding block 2′ includes a ventilation hole 6′ formed into a linear shape. Thus, a portion of the ventilation hole 6′ closer to one of the both ends thereof is located closer to the light emission surface 5a.

If air is sprayed through the thus configured ventilation hole 6′, the air is flowed and sprayed to an outer circumferential portion of the plastic lens indicated by a broken line in the drawing, particularly to the vicinity of the light incidence surface 4a and the light emission surface 5a of the plastic lens. As a result, a depression may be formed in the light incidence surface 4a and the light emission surface 5a, and it may be difficult to guide the depression to a surface other than the light incidence surface 4a and the light emission surface 5a. Further, it may be difficult to preferentially cool a central portion of the plastic lens, i.e., a thick portion of the resin in which the cooling speed is slowest. As a result, the resin temperature may become uneven.

Meanwhile, in the configuration of FIG. 2 described above, the ventilation hole 6 extends along the line defined by the positions each apart from the light incidence surface 4a and the light emission surface 5a by the substantially equal distance. In this case, air is prevented from flowing to the light incidence surface 4a and the light emission surface 5a. Therefore, it is possible to prevent the depression in the resin from being formed in the light incidence surface 4a and the light emission surface 5a. Further, it is possible to set the pressure of the sprayed air to a relatively high value. Therefore, even if a depression is formed in the resin, the depression can be relatively easily guided to a desired location.

In the cooling and solidification process of the molten resin, the cooling speed in the non-light-passing surfaces and inside the plastic lens is higher in a portion closer to the outer circumference of the surfaces, and is slowest in a central portion of the surfaces. Therefore, if cooling air is sprayed to the central portion of a predetermined surface to preferentially cool the central portion, it is possible to effectively prevent the entire resin from having an uneven temperature distribution.

The central portion of the predetermined surface refers to a portion extending along a line defined by positions each apart from the light incidence surface 4a and the light emission surface 5a of the illustrated plastic lens by the substantially equal distance. If air is sprayed through the ventilation hole 6, which is formed in the molding block 2 forming the cavity and extends along the above-described portion, it is possible to preferentially cool the central portion of the corresponding non-light-passing surface of the plastic lens. Accordingly, it is possible to improve the shape accuracy of the ultimately intended plastic lens, and to reduce the internal strain of the plastic lens.

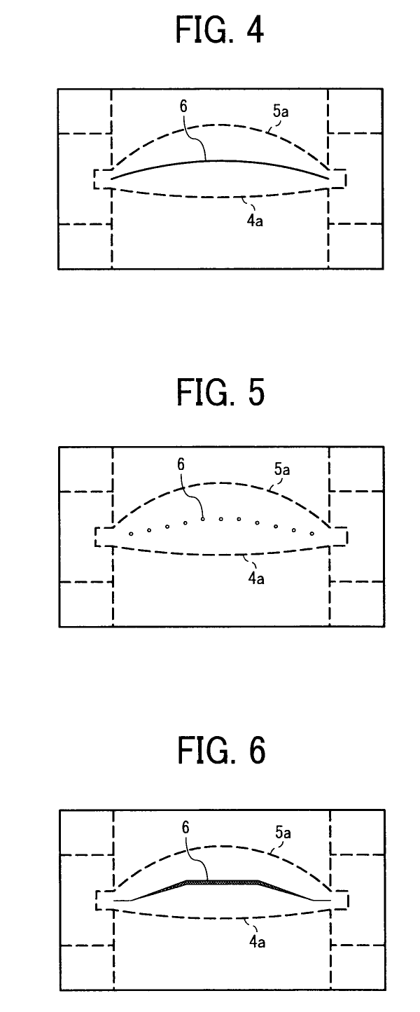

FIGS. 4 and 5 are schematic plan views of other specific examples of the cavity of FIG. 1, as viewed in the direction indicated by the arrow A. In FIGS. 4 and 5, the reference numeral 6 denotes a ventilation hole formed in the molding block 2 forming the cavity. In FIG. 5, the ventilation hole 6 is formed into holes separated from one another. In both of the examples, the ventilation hole 6 extends along a line defined by positions each apart by a substantially equal distance from the light incidence surface 4a and the light emission surface 5a of the ultimately intended plastic lens indicated by a broken line in the drawings. Also in the present examples, if air is sprayed through the ventilation hole 6 formed in the molding block 2 forming the cavity, the central portion of the corresponding non-light-passing surface of the plastic lens can be preferentially cooled. Accordingly, it is possible to improve the shape accuracy of the ultimately intended plastic lens, and to reduce the internal strain of the plastic lens.

FIGS. 6 to 9 are schematic plan views of other specific examples of the cavity of FIG. 1, as viewed in the direction indicated by the arrow A. In all of the present examples, the ventilation hole 6 extends along a line defined by positions each apart from the light incidence surface 4a and the light emission surface 5a of the plastic lens by a substantially equal distance. Further, the width, the hole diameter, and the slit length of the ventilation hole 6 are changed in accordance with the thickness of the plastic lens.

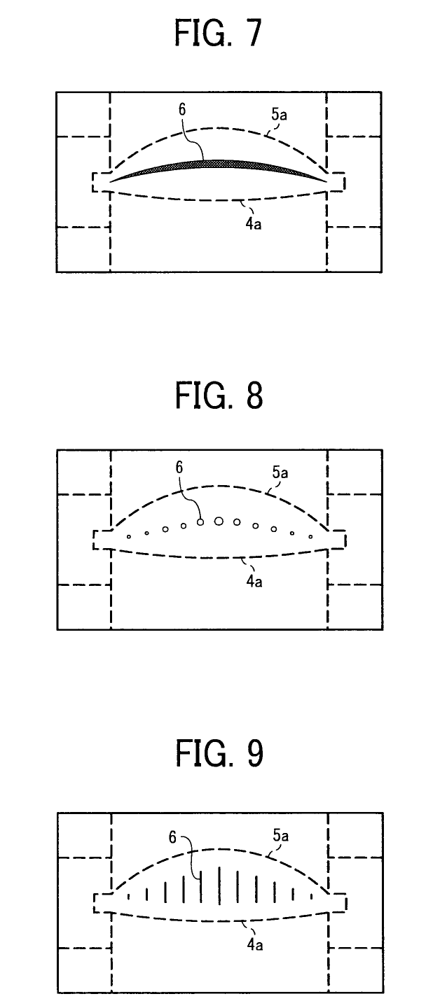

In FIGS. 6 and 7, the ventilation hole 6 is formed such that the width thereof is increased toward a position corresponding to a thick portion of the plastic lens. FIG. 8 illustrates an example in which the ventilation hole 6 is formed into holes separated from one another. In this example, the ventilation hole 6 is formed such that the hole diameter thereof is increased toward a position corresponding to a thick portion of the plastic lens. FIG. 9 illustrates an example in which the ventilation hole 6 is formed into vertically elongated slits separated from one another. In this example, the ventilation hole 6 is formed such that the slit length thereof is increased toward a position corresponding to a thick portion of the plastic lens. In all of the examples of FIGS. 6 to 9, cooling air is sprayed through the ventilation hole 6. With this configuration, a larger amount of air can be applied to a thick portion of the plastic lens than to a thin portion of the plastic lens. As a result, the cooling efficiency in the thick portion can be improved.

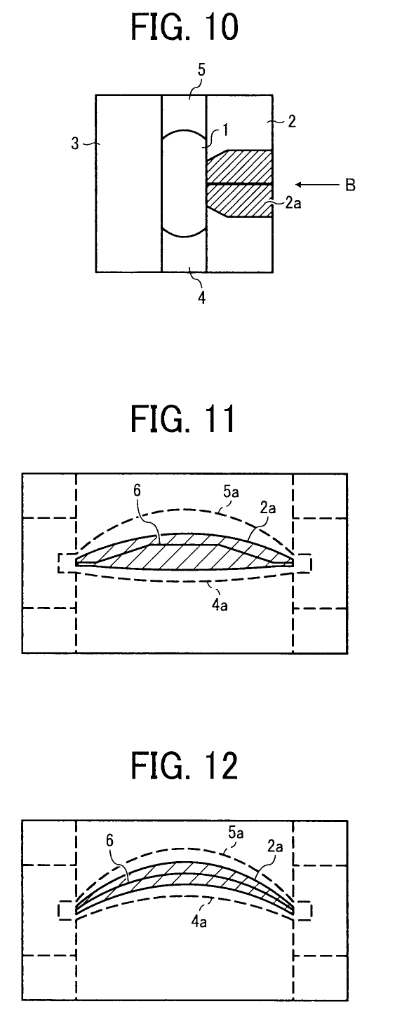

Subsequently, another embodiment of the present invention will be described. FIG. 10 is a schematic view of a cavity of a mold for molding a plastic lens, as viewed in a longitudinal direction of the intended plastic lens. In FIG. 10, the reference numeral 1 denotes the cavity to be filled with a resin, and the reference numerals 2 to 5 denote molding blocks, which are components forming the cavity. Specifically, the reference numerals 2 and 3 denote molding blocks which transfer non-light-passing surfaces of the intended plastic lens. The reference numerals 4 and 5 denote molding blocks which transfer a light incidence surface 4a and a light emission surface 5a, respectively, which are illustrated in FIG. 11. In the present example, the molding block 2, which transfers one of the non-light-passing surfaces of the plastic lens, includes a sliding portion 2a configured to be slidingly movable in a direction separating from the resin.

FIG. 11 is a schematic view of the cavity of FIG. 10, as viewed in the direction indicated by arrow B. FIG. 11 illustrates the positional correspondence relationship between the plastic lens indicated by a broken line in the drawing and the sliding portion 2a and the ventilation hole 6 provided in the molding block 2 forming the cavity. The ventilation hole 6 extends along a line defined by positions each apart from the light incidence surface 4a and the light emission surface 5a by a substantially equal distance.

A resin portion in contact with the sliding portion 2a, which is provided in the molding block 2 transferring a non-optical functional surface, comes into contact with an air space having a relatively low thermal conductance, as compared with a resin portion in contact with the mold. Due to the heat transfer from the inside of the resin, therefore, the temperature of the resin portion in contact with the sliding portion 2a is increased. Thus, the resin portion in contact with the sliding portion 2a is cooled down to room temperature, while maintaining a relationship in which the temperature of the resin is higher on a surface in contact with the air space than on the surface in contact with the mold. As a result, the surface in contact with the air space and the surface in contact with the mold have different contraction amounts of the resin. Herein, the cooling speed on the surface in contact with the air space is higher in a portion closer to the outer circumference of the surface and lower in a central portion of the surface. Therefore, if the central portion is preferentially cooled, the difference in temperature between the surface in contact with the air space and the surface in contact with the mold can be suppressed. Accordingly, deformation of the external shape of the plastic lens can be suppressed.

As illustrated in the drawings, therefore, the sliding portion 2a, which is provided in the molding block 2 transferring one of the non-light-passing surfaces of the plastic lens, is slidingly moved in the direction separating from the molding resin to provide the air space. Thereby, it is possible to preferentially cool the central portion of the rein, and to effectively reduce the difference in temperature between the resin surface in contact with the air space and the resin surface in contact with the mold. Accordingly, the shape accuracy of the ultimately intended plastic lens can be improved.

FIG. 12 is a schematic view of another example of the cavity of FIG. 10, as viewed in the direction indicated by the arrow B. In the present example, the ventilation hole 6 formed in the molding block 2 forming the cavity extends along a line defined by positions each apart by a substantially equal distance from the light incidence surface 4a and the light emission surface 5a of the corresponding plastic lens formed into an arch shape. Also in the present example, the sliding portion 2a, which is provided in the molding block 2 transferring one of the non-light-passing surfaces of the plastic lens, is slidingly moved in the direction separating from the molding resin to provide the air space. Thereby, it is possible to preferentially cool the central portion of the resin, and to effectively reduce the difference in temperature between the resin surface in contact with the air space and the resin surface in contact with the mold. Accordingly, the shape accuracy of the ultimately intended plastic lens can be improved.

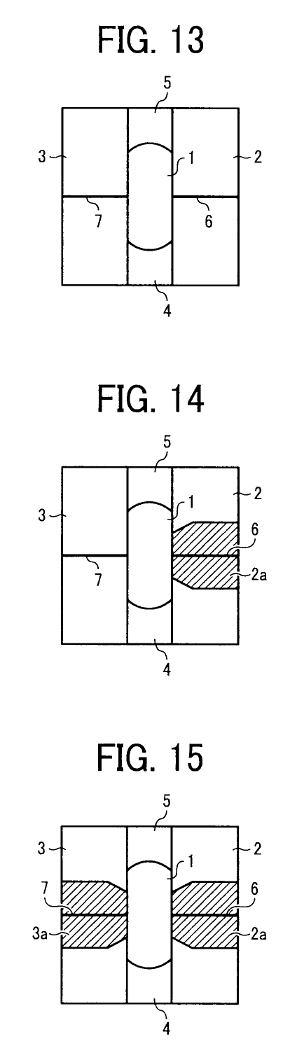

Subsequently, another embodiment of the present invention will be described. FIG. 13 is a schematic view of a cavity of a mold for molding a plastic lens, as viewed in a longitudinal direction of the intended plastic lens. In FIG. 13, the reference numeral 1 denotes the cavity to be filled with a resin, and the reference numerals 2 to 5 denote components forming the cavity. Specifically, the reference numerals 2 and 3 denote molding blocks which transfer non-light-passing surfaces of the intended plastic lens. The reference numerals 4 and 5 denote molding blocks which transfer a light incidence surface and a light emission surface, respectively. In the present example, the two molding blocks 2 and 3, which are located to face each other across the resin, are provided with ventilation holes 6 and 7, respectively.

Subsequently, another embodiment of the present invention will be described. FIG. 14 is a schematic view of a cavity of a mold for molding a plastic lens, as viewed in a longitudinal direction of the intended plastic lens. In FIG. 14, the reference numeral 1 denotes the cavity to be filled with a resin, and the reference numerals 2 to 5 denote components forming the cavity. Specifically, the reference numerals 2 and 3 denote molding blocks which transfer non-light-passing surfaces of the intended plastic lens. The reference numerals 4 and 5 denote molding blocks which transfer a light incidence surface and a light emission surface, respectively. In the present example, the two molding blocks 2 and 3, which are located to face each other across the resin, are provided with ventilation holes 6 and 7, respectively. Further, the molding block 2 provided with the ventilation hole 6 includes a sliding portion 2a configured to be slidingly movable in a direction separating from the resin.

Subsequently, another embodiment of the present invention will be described. FIG. 15 is a schematic view of a cavity of a mold for molding a plastic lens, as viewed in a longitudinal direction of the intended plastic lens. In FIG. 15, the reference numeral 1 denotes the cavity to be filled with a resin, and the reference numerals 2 to 5 denote components forming the cavity. Specifically, the reference numerals 2 and 3 denote molding blocks which transfer non-light-passing surfaces of the intended plastic lens. The reference numerals 4 and 5 denote molding blocks which transfer a light incidence surface and a light emission surface, respectively. In the present example, the two molding blocks 2 and 3, which are located to face each other across the resin, are provided with ventilation holes 6 and 7, respectively. Further, the molding blocks 2 and 3 provided with the ventilation holes 6 and 7, respectively, include sliding portions 2a and 3a, respectively, each of which is configured to be slidingly movable in a direction separating from the resin.

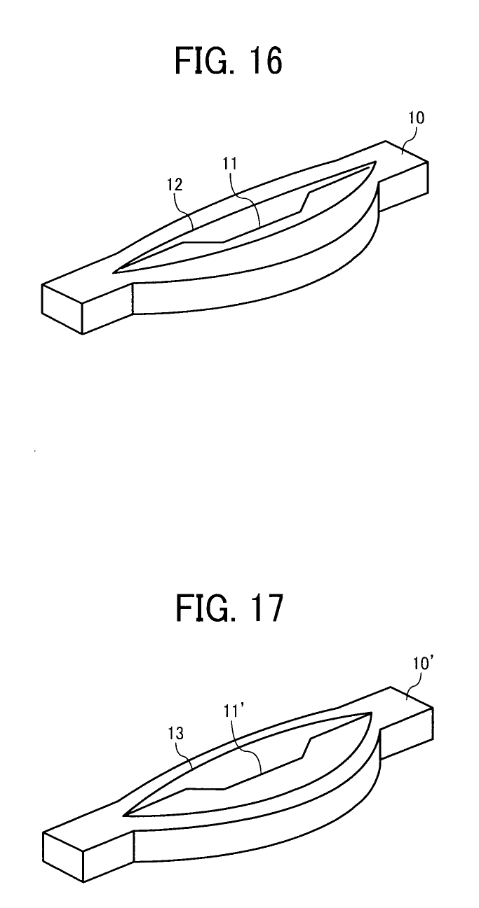

Each of FIGS. 16 and 17 is a schematic perspective view of a plastic lens molded in a mold for molding an optical scanning plastic lens according to an embodiment of the present invention. FIG. 16 is a schematic perspective view of a plastic lens 10 molded in a mold having a ventilation hole extending along a substantial center line between a light incidence surface and a light emission surface of the plastic lens 10. The shape of the ventilation hole formed in a molding block forming a cavity of the mold is transferred to the plastic lens 10. In the plastic lens 10, a depression guiding surface 12 and a streak 11 having a shape similar to the shape of the ventilation hole are formed.

FIG. 17 is a schematic perspective view of a plastic lens 10′ molded in a mold having a ventilation hole extending along a substantial center line between a light incidence surface and a light emission surface of the plastic lens 10′, and also having a sliding portion. The respective shapes of the ventilation hole and the sliding portion formed in a molding block forming a cavity of the mold are transferred to the plastic lens 10′. In the plastic lens 10′, a streak 11′ having a shape similar to the shape of the ventilation hole and the sliding portion and a depression guiding surface 13 having a shape similar to the external shape of the sliding portion are formed.

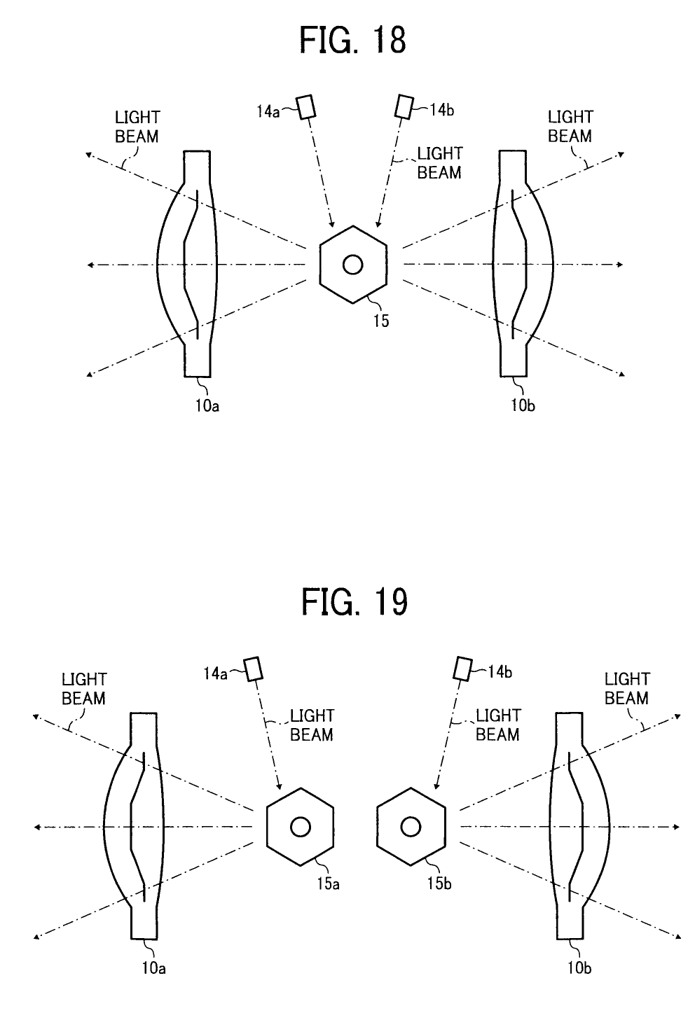

FIG. 18 is a schematic configuration view of essential parts of an example of an optical scanning device including plastic lenses. The optical scanning device is configured to include plastic lenses 10a and 10b, a plurality of light source devices 14a and 14b, and an optical deflector 15. The plastic lenses 10a and 10b are molded in a mold for molding a plastic lens according to one of the embodiments of the present invention described above. The mold includes a ventilation hole extending along a substantial center line between a light incidence surface and a light emission surface of the plastic lens.

FIG. 19 is a schematic configuration view of essential parts of another example of the optical scanning device including plastic lenses. The optical scanning device is configured to include plastic lenses 10a and 10b, a plurality of light source devices 14a and 14b, and a plurality of optical deflectors 15a and 15b. The plastic lenses 10a and 10b are molded in a mold for molding a plastic lens according to one of the embodiments of the present invention described above. The mold includes a ventilation hole extending along a substantial center line between a light incidence surface and a light emission surface of the plastic lens.

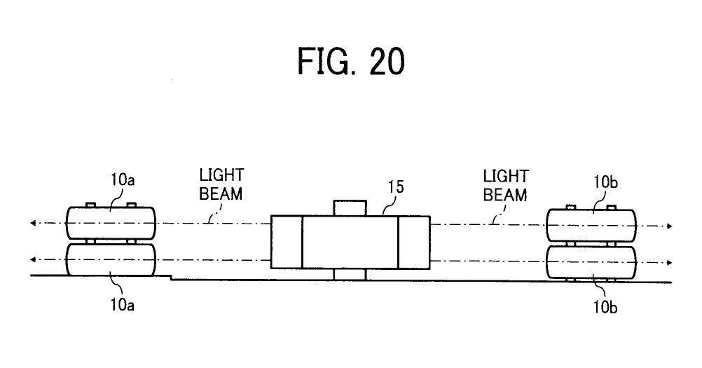

FIG. 20 is a schematic side view of the optical scanning device illustrated in FIG. 18. If a plurality of the optical deflectors 15 are provided in FIG. 20, the configuration of the optical scanning device illustrated in FIG. 19 is obtained.

The optical scanning device described above can be installed in a variety of existing publicly known image forming apparatuses. Installed with the above-described optical scanning device, the image forming apparatuses are improved in the optical characteristic.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape, are not limited the embodiments and thus may be preferably set. It is therefore to be understood that within the scope of the appended claims, the disclosure of this patent specification may be practiced otherwise than as specifically described herein.

1. A plastic lens molded in a mold for molding a plastic lens, the mold for molding a plastic lens comprising:
a pair of first molding blocks configured to transfer a light incidence surface and a light emission surface, respectively; and
a pair of second molding blocks provided to both end portions of the first molding blocks, disposed parallel to an optical axis and facing each other, each configured to transfer a non-light-passing surface, at least one of the second molding blocks including a ventilation hole formed into an elongated slit having a length equal to or longer than a light effective range and extending in a main scanning direction of the light incidence surface and the light emission surface along a line equidistant from the light incidence surface and the light emission surface, through which air is sprayed onto molten resin inside the mold for molding a plastic lens in a process of resin cooling and solidification to facilitate cooling of the resin.

2. The plastic lens as described in claim 1,
wherein at least one of the second molding blocks includes a transfer surface a portion of which is configured to be slidingly movable in a direction separating from the molten resin.

3. An optical scanning device including the plastic lens according to claim 1.

4. An image forming apparatus including the optical scanning device according to claim 3.

5. The plastic lens as described in claim 1,
wherein the plastic lens is used for laser light application.
